(19) United States
(12) Patent Application Publication
(10) Pub. No.: US 2014/0304124 A1
(43) Pub. Date: Oct. 9, 2014

(54) Method for Creating Individual Shelf Images for Different Points of Sale

(71) Applicant: HOFFROGGE CONSULTING COMPANY GMBH, Wildeshausen (DE)

(72) Inventors: Maik Amelmann, Wildeshausen (DE); Stefan Oltmann, Wildeshausen (DE); Wilhelm Hoffrogge, Wildeshausen (DE)

(21) Appl. No.: 14/110,681

(22) PCT Filed: Apr. 10, 2012
(86) PCT No.: PCT/EP12/01550

§ 371 Date: Dec. 23, 2013

(30) Foreign Application Priority Data
Apr. 9, 2011 (EP) 11002995.6

(51) Int. Cl. G06Q 10/08

(52) U.S. Cl. CPC G06Q 10/087
USPC 705/28

(57) ABSTRACT

A method for operating a data processing unit according to a program for creating

individual shelf images for a multitude of points of sale (POS) of a trading firm,

including

accessing assortment data which define an individual assortment of different items with attributes for every POS,

offering a user to interactively define blocks via input- and output devices, each block comprising items with at least one attribute specific for the block,

accessing the blocks in a data memory,

accessing shelf data with data of at least one shelf of every POS in a data memory,

offering the user to interactively develop a sequential order of placement rules,

accessing the order of placement rules in a data memory and for each POS, applying placement rules, and determining the placement positions of items in the shelf of the POS, and

visualizing the placement positions of the items in a shelf image.

### CROSS-REFERENCE TO RELATED APPLICATIONS

This is a national stage application of PCT/EP2012/001550, filed on Apr. 4, 2012 and claiming priority to EP 11 002 995.6 filed on Apr. 9, 2011

### STATEMENT REGARDING FEDERALLY SPONSORED RESEARCH

Not applicable.

### BACKGROUND OF THE INVENTION

The present invention relates to a method for operating at least one data processing unit according to at least one program for creating individual shelf images for a multitude of different points of sale (POS) of a trading firm,

The shelves in POS of trading firms are filled using shelf images (also called “planogram”). A shelf image is a depiction of a shelf filled with different items. The shelf image represents the number of shelf panels and, in case, of segments of the shelf Further, the proportions of the shelf are visualised in a realistic manner. The items are represented such that they can be identified by the observer. Shelf images are mostly photo-realistic graphics. They serve the personnel in the POS as patterns for filling the shelves. The different items are put into the shelf corresponding to this pattern. This holds for the complete filling of the shelf as well as for the refill after partial depletion. In making a shelf image, the assortment to be offered is distributed into the respective shelf taking into account its specific dimensions, number of shelf panels, shelf heights and segments and the varying demand for different items, as well as the different attractiveness of the locations in the shelf.

In a known computer program for making shelf images, a mother planogram is generated by the user for a concrete shelf of medium size by individually specifying the position and number of each item. This mother planogram serves as a pattern for making further shelf images for further shelves having different dimensions in the same or other POS. Derivatives are generated from the mother planogram, which are adapted to the conditions of the respective shelves. For this purpose, the number of items of the same kind, which stand in the foremost front of the shelf, are converted according to the proportions of the shelf for which the mother planogram was made, and the shelf for which the derivative is intended to make.

Creating the mother planogram and the derivative is complicated. The derivatives must be regularly corrected manually, because the conversion does not lead to accurately fitting results. Moreover, it is disadvantageous that deriving derivatives from a mother planogram does not adapt to location-specific peculiarities. That is to say, many items are demanded in very different degrees, depending on the location of the POS. The dependency of the demand is in turn strongly dependent on the product category. For washing agents, the dependency of the demand from the location of the POS is only small. For beverages, in particular for beer, the dependency of the sales of certain items from the respective location is very marked. This is taken into account by complicated manual post-processing of the derivatives. Making a mother planogram as well as making the derivatives takes much time, which can amount to the range of a whole workday.

The document US2005/0203790 A1 describes an automatic method for providing shelf images using rule-based commands. Planograms specific for a POS location are created using business rules related to the POS location. The business rules are translated into mathematical equations using an artificial intelligence, which are used for optimum placement of the products in a shelf.

The document DE 10 2005 021 432 A1 describes a method for memorising and organising information concerning the arrangement of items (for instance planograms or shelf images). The method comprises to provide electronic files, which contain information concerning the arrangement for several items of a POS. The electronic files are memorised, and a collection file is generated which includes identification information of the electronic files. In a variant of the method, the real number of units of the items is determined and compared with a minimum number of units of the items. Furthermore, a sales point assignment is known by which plenty of planograms can be collocated and organised. The system offers the user to select a combination of available planograms in order to define several sections of a shop.

The document US 2007/0288296 A1 describes a computer-implemented method for producing a shelf image for the placement of items in shelves. An initial arrangement of items is provided in a two-dimensional lattice structure corresponding to the physical sales block. The lattice structure is normalized with respect to the physical characteristics of the products. A plurality of logical inventory blocks is provided within the sales block. A prioritised list of products is made from the normalised lattice structure. The prioritised list of products has at least two priority levels for each inventory block. The products of the priority list are placed in the inventory blocks. The final arrangement of products within the inventory blocks is evaluated in order to determine optimum placement of products. The shelf image is issued and evaluated for each combination of products from the priority list. The optimum placement of products includes the selection of an optimum evaluation of the product placement.

This method has the disadvantage that the user must provide a complete shelf image in the beginning. The development of a shelf image for a certain POS is complicated. The distribution of the items from the shelf image into blocks takes place according to a priority list. Items which differ with respect to all the properties can be placed into the same blocks.

Starting from this, the present invention is based on the objective to provide a method for creating individual shelf images for different POS which can be executed more quickly and facilitates to account for varying demands for items at different POS.

### BRIEF SUMMARY OF THE INVENTION

The method of the present invention for operating a data processing unit according to a program for creating individual shelf images for a multitude of different points of sale (POS) of a trading firm comprises the following steps:
the program accesses assortment data which define an individual assortment of different items with associated attributes for every POS,
the program offers an user to interactively define different blocks, each block comprising one or several items with at least one attribute that is specific for the block,
the program accesses shelf data with the individual data of at least one shelf of every POS
the program offers the user to interactively establish a hierarchical order of placement rules, which relate to the placement of different blocks in shelves,
after completed definition of blocks and establishment of the order of placement rules for each POS, the program applies the placement rules sequentially, according to their order, to the blocks with the items from the assortment of the POS, and determines the placement positions of the different items in the shelf of the POS, taking into account the shelf data, and visualises them in a shelf image.

According to one embodiment, the method of the present invention for operating at least one data processing unit according to at least one program for creating individual shelf images for a plurality of different POS of a trading firm comprises the following steps:
the program accesses assortment data which define an individual assortment of different items with associated attributes for every POS,
the program offers an user to interactively define different blocks via input- and output devices, each block comprising one or several items with at least one attribute that is specific for the block,
after completed definition of blocks by the user, the program accesses the blocks in a data memory,
the program accesses shelf data with the individual data of at least one shelf of every POS in a data memory,
the program offers the user to generate a hierarchic or sequential order of placement rules interactively via input- and output devices, which relate to the placement of different blocks in shelves,
after completed establishment of the order of placement rules, the program accesses the order of placement rules in a data memory, and
the program applies the memorised placement rules sequentially for each POS, according to their order, to the memorised blocks with the items from the assortment of the POS, and determines the placement positions of the different items in the shelf of the POS, taking into account the shelf data, and
the program visualises the determined placement positions in a shelf image.

In the method of the present invention, the programs goes back to assortment data of the group of goods to be optimised (i.e. the entirety of product alternatives for satisfying a need which are substitutable in the consumer's opinion—for instance category “washing agents” consumer need “to wash clothes”). These assortment data comprise all the items which are sold in the different POS of a trading firm. Further, the assortment data for each item comprise the respective associated attributes. By way of example, this is a matter of one or several of the following attributes: the kind, the producer, the brand, the amount, the geographic origin, the colour, the size, the package type and other properties of the item. The assortment data determine the individual assortment for each POS for which the method generates shelf images. The assortment data are extracted for instance from market research data concerning the items of the assortment of a trading firm, investigated for a greater distribution area, and from the individual sales data of the different POS of the trading firm. The market research data are linked with the individual sales data of the different POS in order to determine the individual assortment of the POS. In order that the program can access the assortment data, the assortment data can be stored in a data memory, to which the program has access.

Further, the program offers a user to interactively define different blocks via input- and output devices, each block comprising one or several items with at least one attribute that is specific for the block. Defining a block can consist in a completely new collocation of items to a block, or in the assignment of at least one item to an already previously defined block. Each block comprises items with an attribute which is specific for the respective block. Items from other blocks do not have this attribute. Defining the blocks is assisted or simplified by the attributes, and thus it is based on rules. For instance, this permits the user to form specific blocks, whose peculiarity is that they are items of the same kind, the same producer, the same brand, the same amount, the same geographic origin, the same colour, the same size, the same package type or items with other same properties. A block can also be specified by several same properties of items contained therein. The user-defined blocks having items with at least one specific attribute can be stored in a data memory to which the program has access.

Furthermore, the program accesses shelf data with the individual data of the shelves of the different POS. For instance, these individual data comprise the dimensions of the shelves, the number of shelf panels, the length, the depth and the height of the shelf panels and the number of segments of the shelf The program can access shelf data of one or several shelves of the same POS. The shelf data can be found out in the POS or be provided by the trading firm. They can be stored in a data memory to which the program has access. These data can be gathered by the user or be provided by the producer. According to one embodiment, they are put into the data processing unit by the user via an input device. According to another embodiment, the data processing unit goes back via an interface to existing data, which are provided for instance by the user or from the producer of the shelf.

Further, the program uses placement rules which are arranged in a sequential order. The placement rules dictate the program according to which rules (for instance where and in which sequence) the different blocks must be placed in the shelves. The placement rules can extend to the placement of the items in the blocks. The establishment of the sequential order of placement rules is made interactively by the user. This activity can be limited to setting the order of given placement rules. Further, this activity can comprise the duplication or modification of given placement rules. It can comprise the definition of placement rules by the user.

For instance, one or several placement rules are selected from rules which relate to the placement of the blocks in a shelf with standardised dimensions, instead in a shelf with individual shelf data. Further, they can indicate the placement of certain blocks on a certain shelf panel, in a certain position of the shelf panel or in a certain shelf segment. Furthermore, the placement rules can indicate a placement of blocks or items in a certain direction or in a given order. The order can be an alphabetical order, which can relate to the name of the producer or the brand of the item in particular. Further, the placement rules can indicate the placement in an order determined by at least one dimension and/or the weight and/or the amount and/or the price. Furthermore, placement rules can specify the placement of the items in an order given for certain kinds of items, or in an order given for groups of different items. Furthermore, placement rules can relate to the observance of certain free spaces and/or of spaceholders on certain positions of the shelf Further placement rules can be rules to fill up those places of the shelf which remain empty after applying the remaining placement rules. Further, placement rules can indicate the placement of an item, which is introduced into the assortment of the trading firm anew, on a certain position of the shelf.

The placement rules can be stored in a data memory to which the program has access.

After sorting items of the assortment into blocks, and after establishing the order of placement rules for all the POS, the program generates individual shelf images. For this purpose, the program implements the placement rules for each POS consecutively according to their order. In this, each placement rule from the hierarchical sequence of placement rules is applied to the blocks. Taking into account the shelf data, the placement positions of the different blocks, and thus of the items contained therein, are determined for the shelf of the respective POS and visualised in a shelf image. If need be, the shelf images are determined for several shelves of the same POS, wherein the individual shelf data of the respective shelf are taken as basis. The method assigns an individual shelf image to the shelf of each POS, because only those items are taken into account in the blocks which belong to the assortment of the POS. In addition, the individual data of the respective shelf of the corresponding POS are taken as basis in the establishment of the shelf images. For filling up shelves, the shelf images can be printed—preferably in colour—and/or shown in a display of a portable display device.

In this application, with “interactive” is meant a methodology wherein the user communicates with a data processing unit in a dialogue. In this dialogue operation of the data processing unit, the user can exchange information and data directly with the data processing unit by mutual question and answer via input- and output devices. In this way, the user notably gets the opportunity to define blocks in the dialogue operation and to create a sequential order of placement rules.

Thus, the method of the present invention permits the user for the first time to create individual shelf images for a plurality of different POS (that is to say, for different retail shops) in a high speed. The method is particularly suited for creating shelf images for the shelves of retail organisations, in particular of food chains, drug-store companies and oil companies, which are all trading firms in the sense of this patent application.

According to one embodiment, the method of the present invention is executed using only one data processing unit. According to another embodiment, the method is executed using a network comprising several data processing units. According to a further embodiment, the method is executed using one single program. According to a further embodiment, the different parts of the method are executed using different programs. For instance, the blocks are defined using a program, and/or the order of placement rules is established on a separate data processing unit, and the rest of the method is executed using a further program on a further data processing unit.

The method can envision from out the outset that the program accesses the assortment data of one single trading firm. Making shelf images of a trading firm is also designated as “the project”. According to one embodiment, more comprehensive assortment data are taken as the basis of the method, which can comprise the assortment data of several POS (the retail business) of a trading firm. In this embodiment, the program offers the user to select the assortment data of a certain POS from a collection of assortment data interactively. The selected assortment data can be stored in a data memory to which the program has access. In this embodiment, the method can create shelf images for different POS, or take the add-ons to an assortment of a POS into account more easily.

The shelf images can assign several places in the foremost rows of the shelf (the so-called “facings”) to several items. Several placement positions in the foremost rows of the shelf are preferably assigned especially to items with high sales. According to one embodiment, the assortment data comprise the indication how many pieces of the respective items are to be arranged in the foremost rows of the shelf For instance, this number can be set by way of the data concerning the sales of the different items in the different POS. According to a further embodiment, the program offers the user to interactively set the number of each item in the foremost rows of the shelf Then, taking into account the peculiarities of the POS, actual trends and so on, the user can specify how many pieces of each item are to be arranged in the foremost rows of the shelf.

According to a further embodiment, the assortment data comprise the individual assortment of different items with data concerning the sales for each POS, and the program determines the number of each item in the foremost rows of the shelf, depending on the opening times for which the shelf content should suffice without having to refill the shelf The opening times are preferably a matter of periods from one to several opening days. But they may also be a matter of opening days or opening times of a POS. The number of the items is preferably determined proportionally to the sales by the program. In a simple case, the relation between the number of each item and the sales is linear.

According to one embodiment, the program arranges the blocks defined by the user in proper order into groups, and visualises them on a screen. According to a further embodiment, the program visualises the different blocks in different colours on a screen. According to a further embodiment, the program offers the user the interactive assignment of an individual colour to each block and visualises the blocks in the colours selected by the user on a screen.

According to one embodiment, the program offers the user memorised placement rules and interactive processing of the hierarchical sequence and/or the contents of the placement rules. According to a further embodiment, the program offers the user to interactively define own placement rules. The program can offer the user the interactive processing of memorised placement rules and to interactively define own placement rules.

According to a further embodiment, the program offers the user to interactively modify shelf images. This permits the user to post-process the shelf images generated by the program by applying the placement rules to the blocks and the shelf data. For instance, the placement of individual items which appears to be inappropriate in the overall view of the shelf image can be modified by post-processing. In case that the shelf image has gaps, these can be filled up in the post-processing. In case that too many items are provided for the shelf, items can be dropped in the post-processing. Such an overfill of a shelf can be visualised in the shelf image by depicting several items superposedly, or items which cannot be accommodated in the shelf are shown in the shelf image so as to be laterally set out of the shelf.

The data processing unit may be a single computer or a computer network.

### BRIEF DESCRIPTION OF THE SEVERAL VIEWS OF THE DRAWINGS

The present invention will be explained in more detail in the following by way of the attached representations of an example of its realisation. In the representations show:

FIG. 1 a data flow chart of the method of the invention;

FIG. 2 a cut-out from assortment data;

FIG. 3 a cut-out from the placement rules;

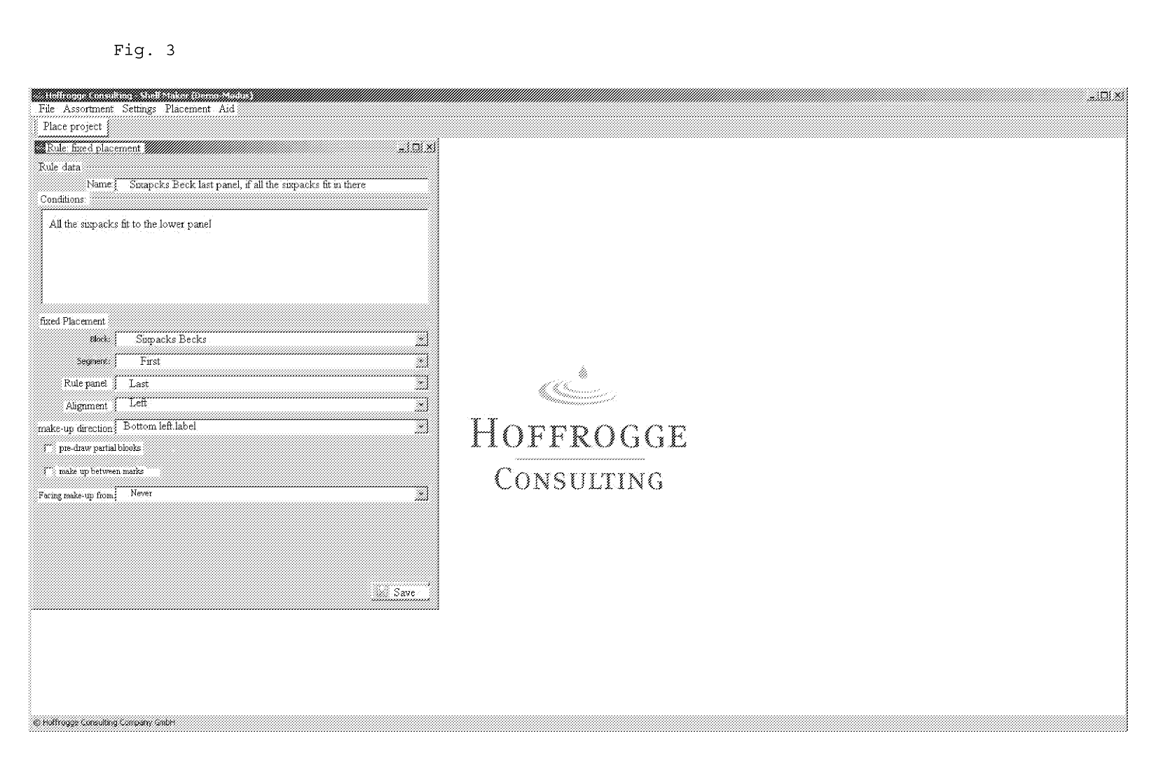

FIG. 4 a cut-out from the assortment data, ordered in blocks;

FIG. 5 a cut-out from the placement rules arranged in an order;

FIG. 6 a cut-out of a compendium of POS for which planograms were made;

FIG. 7 a planogram before the post-processing;

FIG. 8 the planogram after the post-processing;

FIG. 9 the planogram in a three-dimensional (3D-) representation.

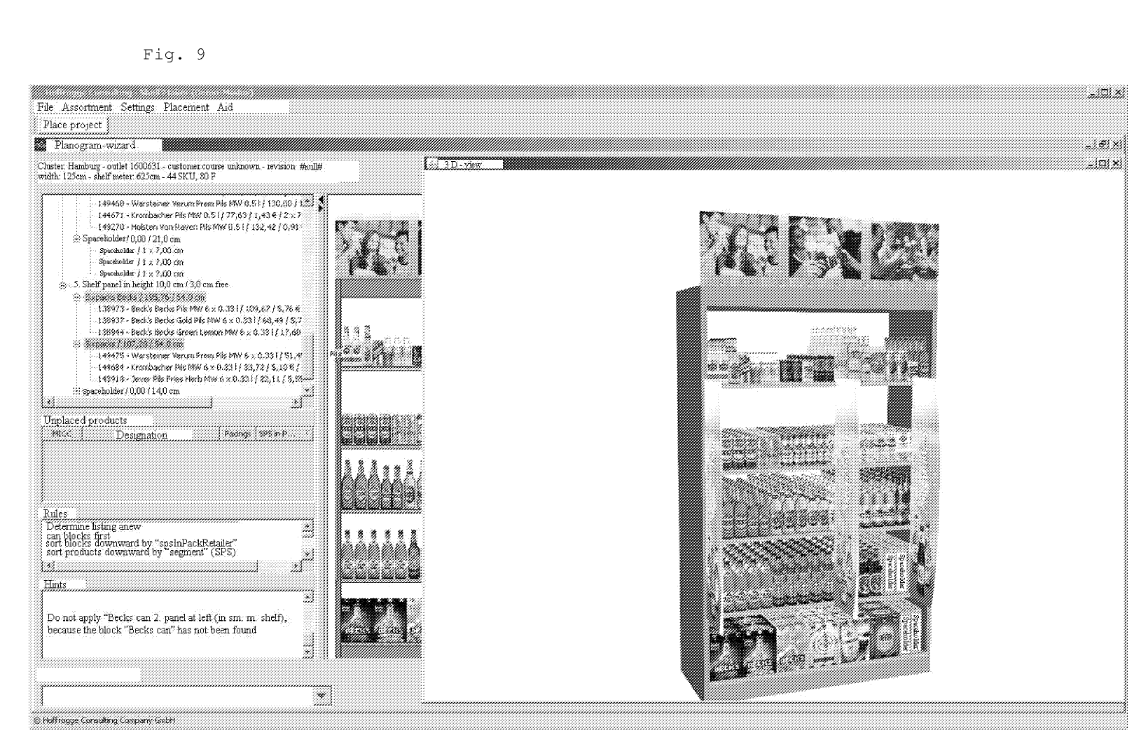

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

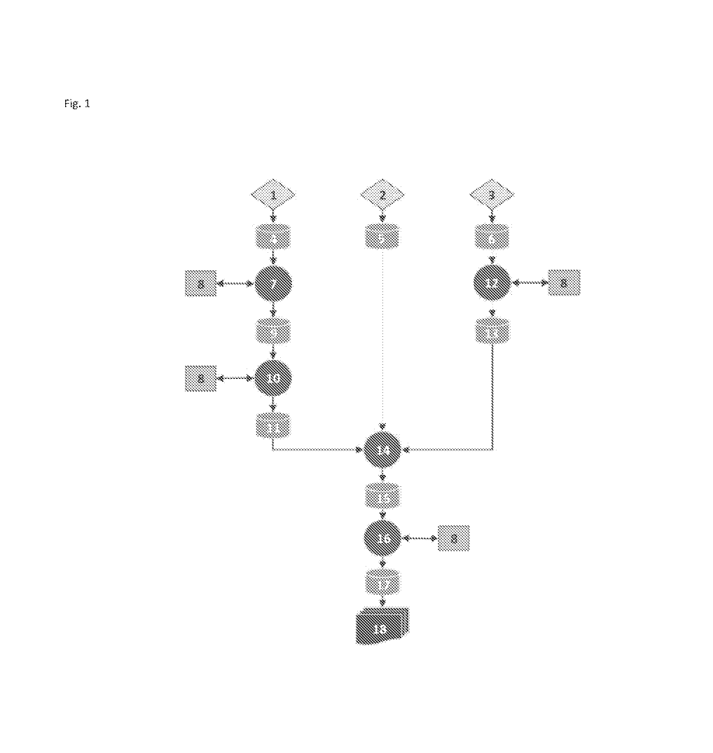

According to the data flow chart of FIG. 1, assortment data are fed to the method via an interface 1, shelf data via an interface 2 and placement data via an interface 3. These data are filed in data memories 4 for assortment data, 5 for shelf data and 6 for assortment data.

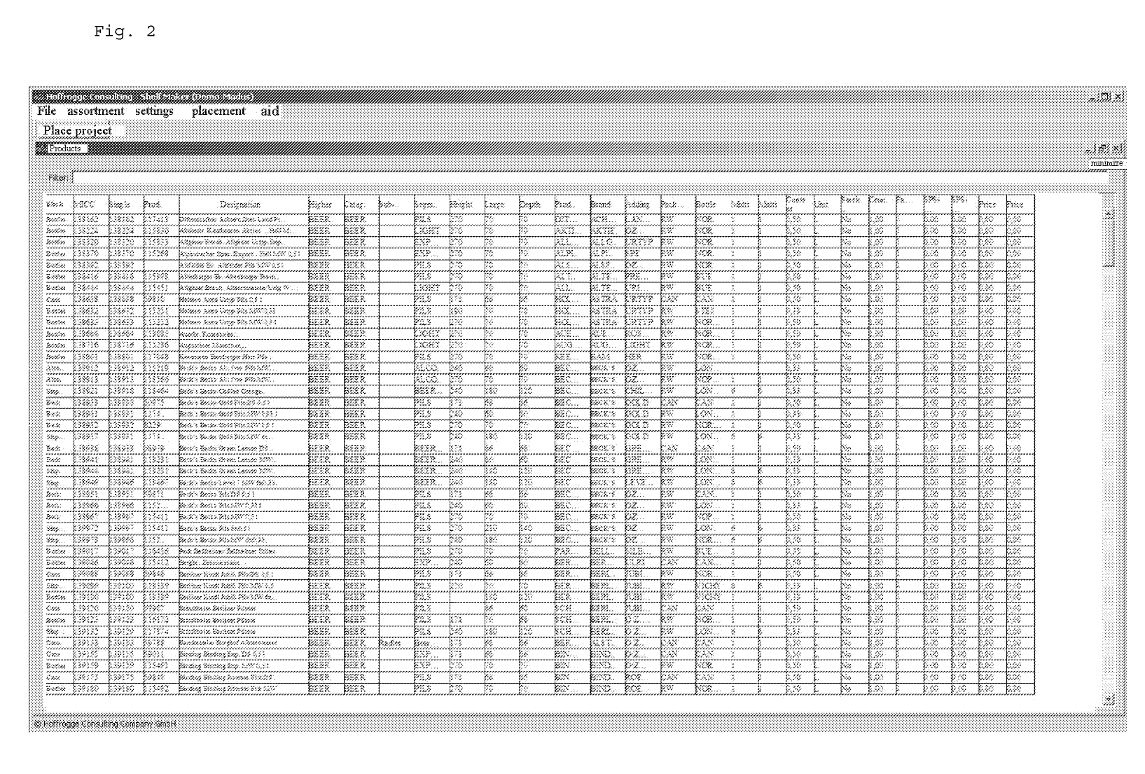

FIG. 2 shows a cut-out from the assortment data, and FIG. 2 shows a cut-out from the placement rules.

The assortment data exceed the assortment of the POS for which shelf images are made. Via an interactive process 7 with an interface 8 towards the user, the assortment data of the respective POS are selected from the assortment data and memorised in a data memory 9.

In an interactive process 10 with the interface 8 towards the user, the assortment data of the trading firm from the data memory 9 are ordered in blocks which are memorised in the data memory 11. The blocks comprise one or several items with a common attribute or a common combination of attributes.

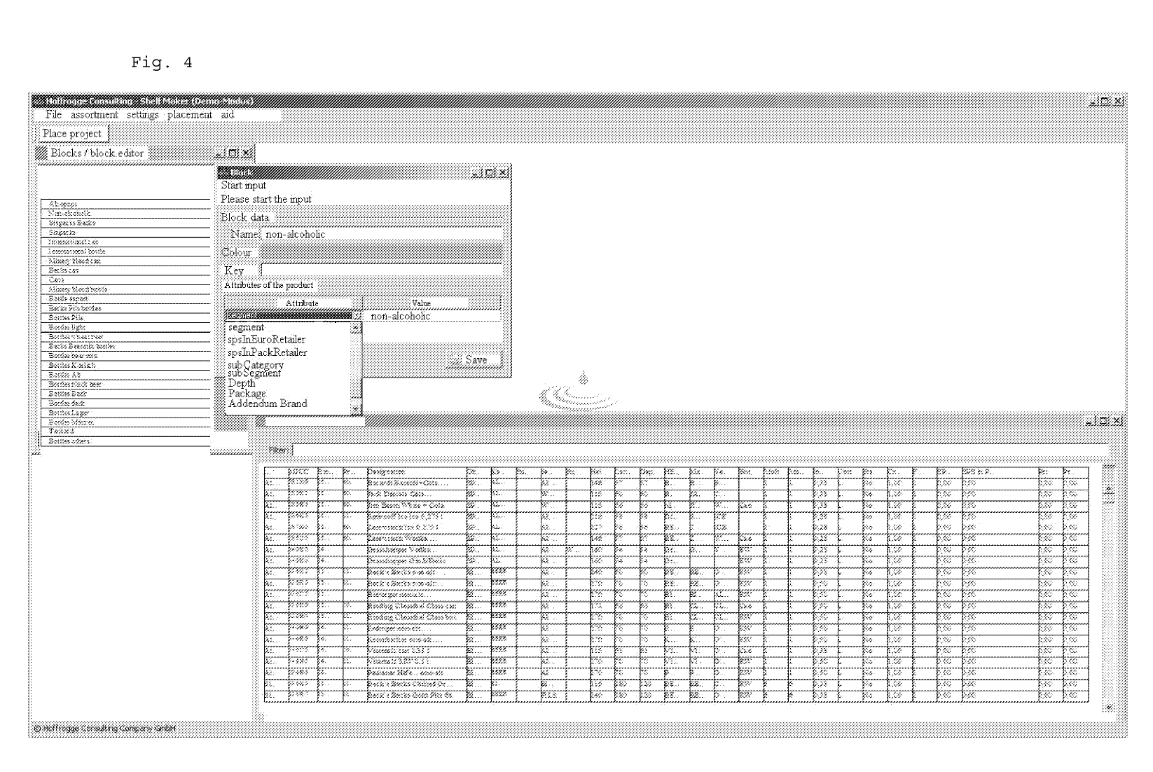

FIG. 4 shows a cut-out from the assortment data ordered in blocks;

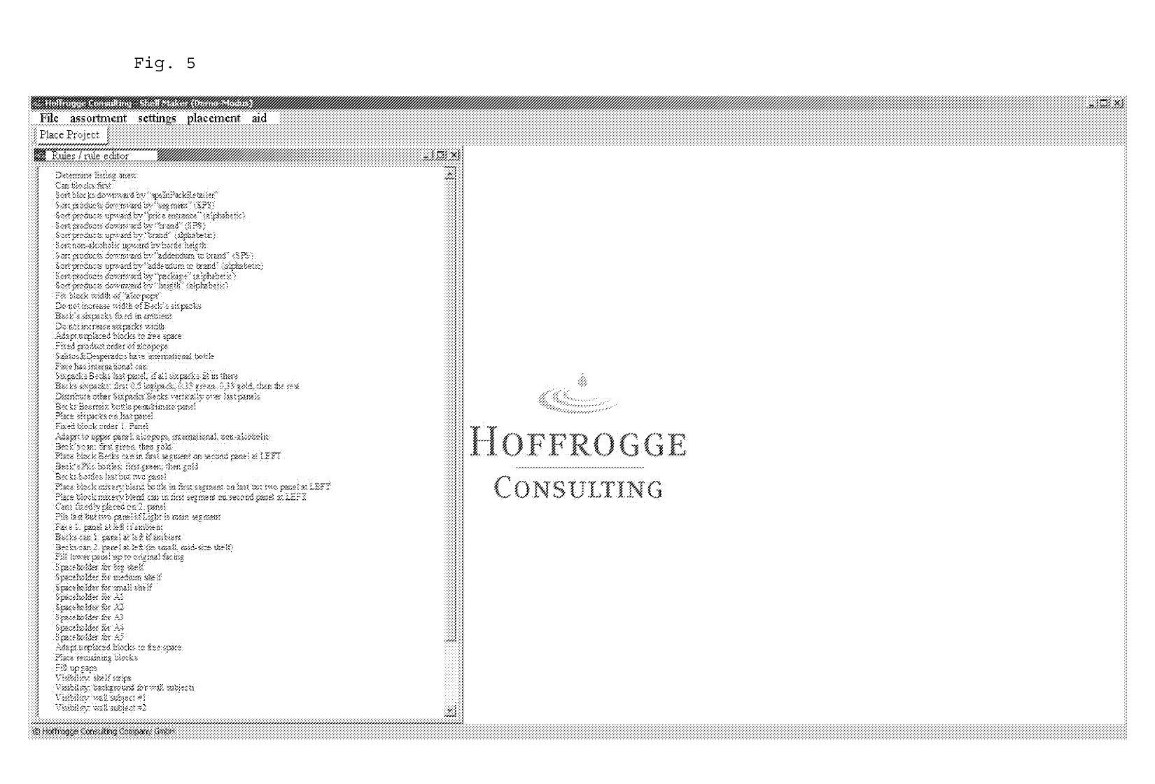

The placement rules from the data memory 6 are brought into a certain order by the user in an interactive process via the interface 8. In this, the user has the opportunity to modify the placement rules or to define own placement rules, and to take the modified or self-defined placement rules into account in the order. The order of placement rules established or defined by the user is memorised in a data memory 13. A cut-out from the placement rules arranged in a certain order is shown in FIG. 5.

The blocks from the data memory 11, the shelf data from the data memory 5 and the placement rules brought into a certain order from the data memory 13 are processed to shelf images in an automatic computation process 14. For this purpose, the computation process 15 consults each placement rule sequentially, and applies it to the blocks and the shelf data of a certain shelf of a POS. Thus, the corresponding shelf is individually filled with items.

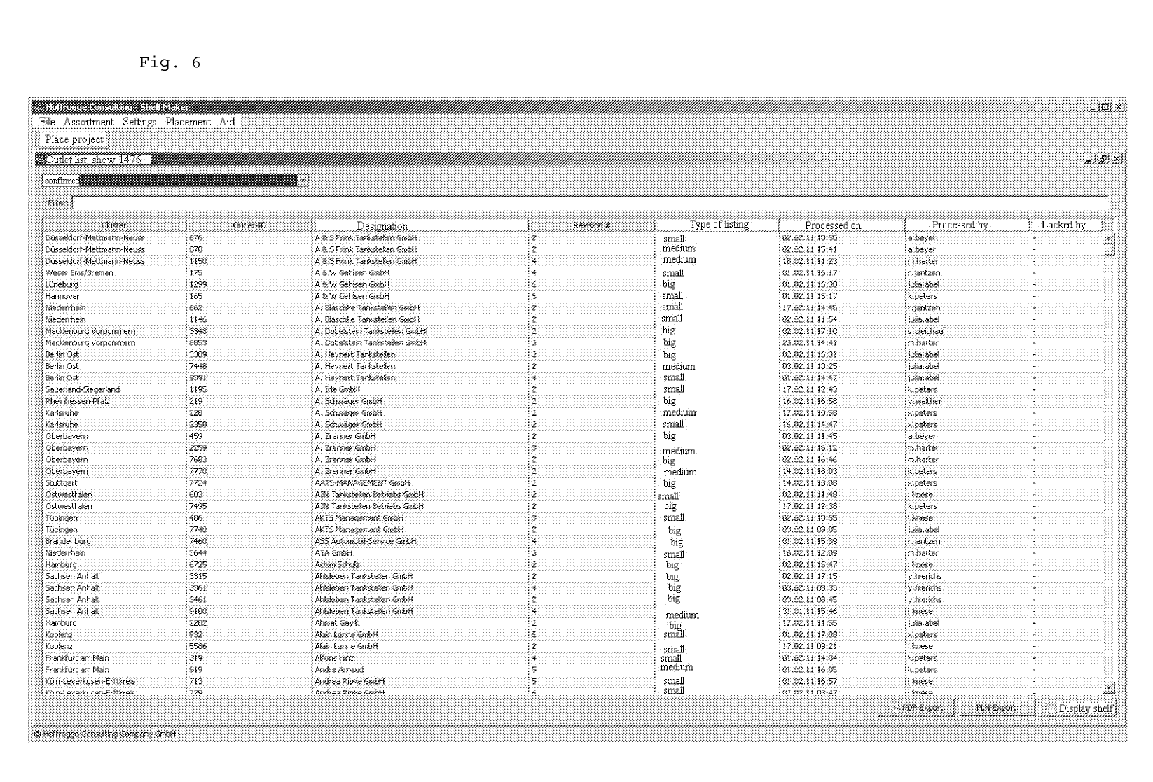

The process is performed for all the POS of the trading firm. The case given, it is performed for several shelves of each POS. The established shelf images are memorised in the data memory 15. A cut-out from a compendium of POS for which shelf images were made is shown in FIG. 6.

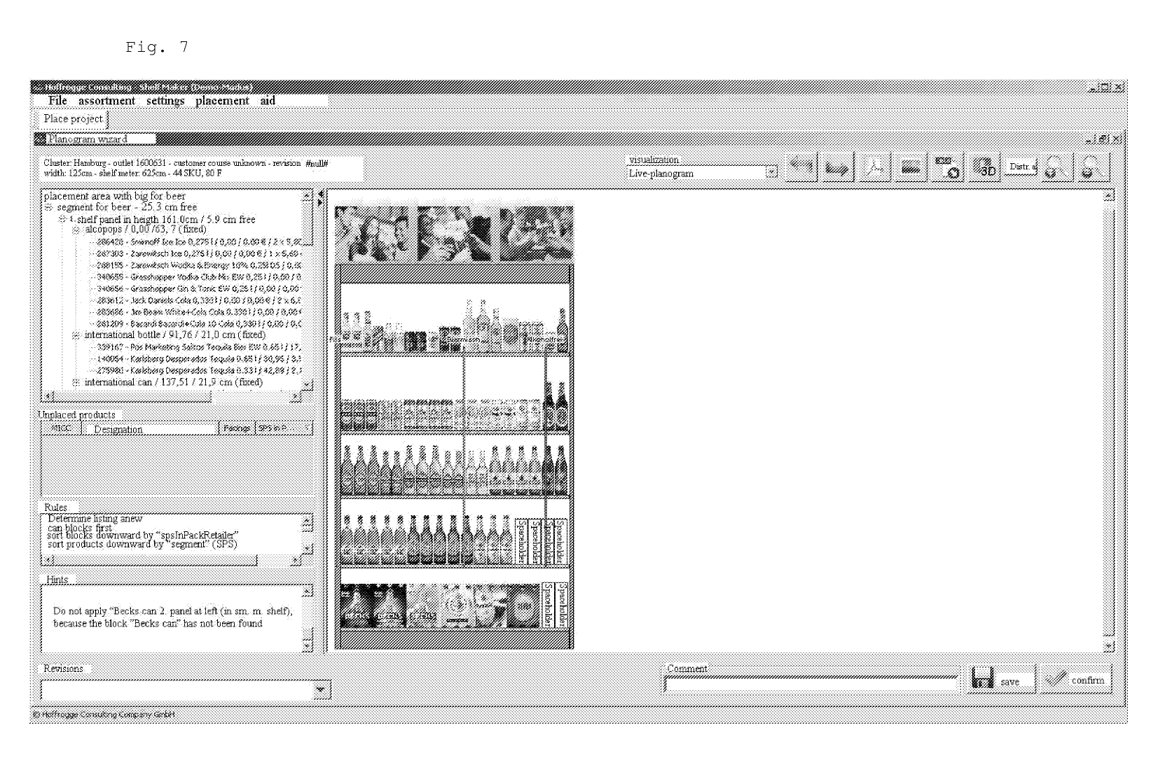

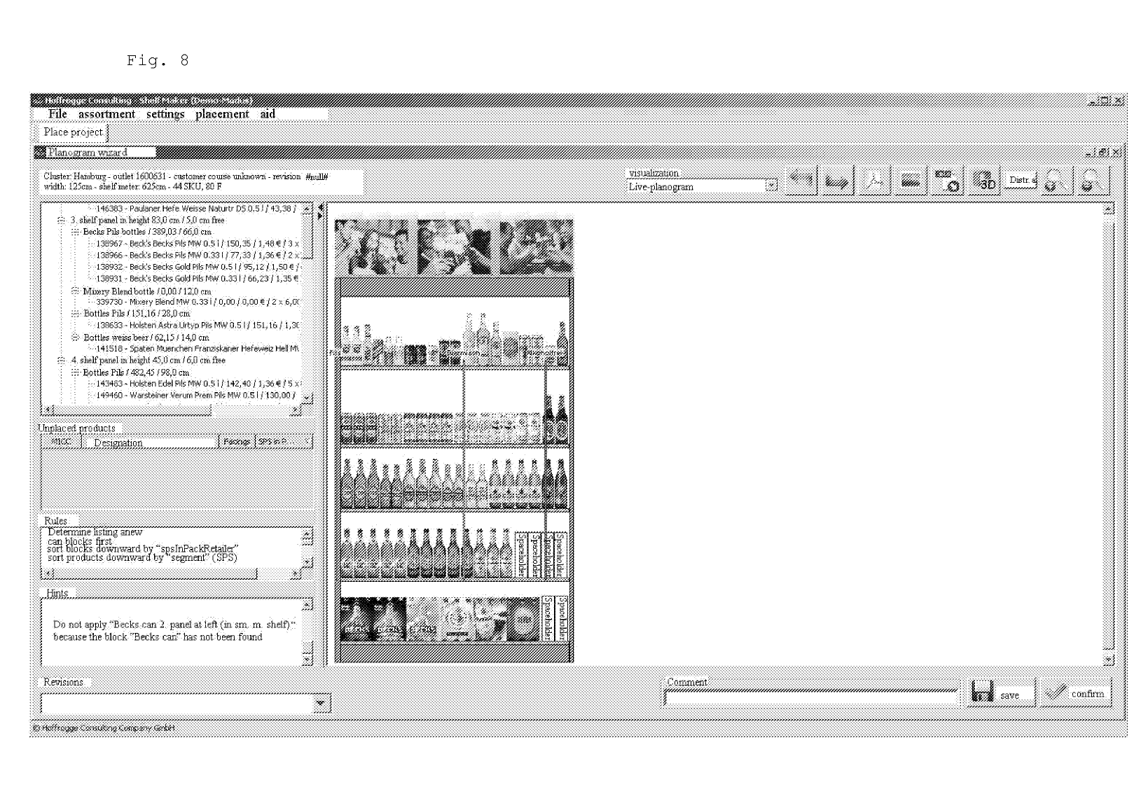

The case given, the shelf images from the data memory 15 are post-processed in an interactive process 16 with an interface 8 towards the user. FIG. 7 shows a compiled shelf image before, and FIG. 8 the shelf image after the post-processing. The post-processed shelf images are memorised in a data memory 17 and put out by an output device 18.

FIG. 5 shows a 3D-representation of the shelf image, which can also be generated by the program.

While this invention may be embodied in many different forms, there are described in detail herein a specific preferred embodiment of the invention. This description is an exemplification of the principles of the invention and is not intended to limit the invention to the particular embodiment illustrated.

1. A method for operating at least one data processing unit according to at least one program for creating individual shelf images for a multitude of different points of sale (POS) of a trading firm, comprising the steps of
the program accesses assortment data which define an individual assortment of different items with associated attributes for every POS,
the program offers an user to interactively define different blocks via input- and output devices, each block comprising items with an attribute that is specific for the block,
after completed definition of blocks by the user, the program accesses the blocks in a data memory,
the program accesses shelf data with the individual data of at least one shelf of every POS in a data memory,
the program offers the user to interactively develop a sequential order of placement rules, which relate to the placement of different blocks in shelves,
after completed input, the program accesses the sequential order of placement rules in a data memory and
for each POS, the program applies the memorized placement rules sequentially according to their order to the memorized blocks with the items of the assortment from the POS, and determines the placement positions of the different items in the shelf of the POS, taking into account the shelf data, and
the program visualizes the placement positions of the different items in a shelf image.

2. The method according to claim 1, wherein the program offers the user to interactively select the assortment data of a certain trading company from a more extensive collection of assortment data.

3. A method according to claim 1, wherein the program offers the user to interactively specify the number of each item in the forefront rows of the shelf.

4. A method according to claim 1, wherein the assortment data for every POS comprise the individual assortment of different items with data concerning the sales, and the program determines the number of each item in the forefront rows of the shelf depending on the sales and the business hours for which the shelf contents are estimated to be sufficient without filling the shelf again.

5. A method according to claim 1, wherein the program offers the user to interactively define blocks of items having common attributes, the common attributes being selected from the kind, the producer, the brand, the amount, the geographic origin, the color, the size, the package type and other properties of the item.

6. A method according to claim 1, wherein the program visualizes different blocks in different color on a screen.

7. A method according to claim 1, wherein the program offers the user to interactively assign a certain color to each block, and visualizes the blocks in the colors selected by the user on a screen.

8. A method according to claim 1, wherein one or several placement rules are selected from rules which dictate the placement in a shelf having standardized dimensions, of certain blocks on a certain shelf panel, on a certain position of the shelf panel, in a certain shelf segment, in a certain direction in a given order, in alphabetic order, in an order determined by at least one dimension and/or the weight and/or the amount and/or the price, in an order given for different kinds of items, in an order given for groups of different items, the observance of certain free spaces and/or spaceholders at certain positions of the shelf, filling empty places and the placement of an item that has been newly added to the assortment.

9. A method according to claim 1, wherein the program offers the user memorized placement rules and interactive processing of the hierarchic order and/or the contents of the placement rules.

10. A method according to claim 1, wherein the placement rules relate to the sequence of different items in the blocks.

11. A method according to claim 1, wherein the program offers the user to interactively define own placement rules.

12. A method according to claim 1, wherein the program offers the user to interactively modify shelf images.
